(19) United States
(12) Patent Application Publication
(10) Pub. No.: US 2016/0180308 A1
(43) Pub. Date: Jun. 23, 2016

(54) AUTOMATIC PURCHASING OF DIGITAL CONTENT

(71) Applicant: Google Inc., Mountain View, CA (US)

(72) Inventors: Daniel Chak, San Francisco, CA (US); C. J. Scott Dougall, Palo Alto, CA (US)

(21) Appl. No.: 14/580,056

(22) Filed: Dec. 22, 2014

(51) Int. Cl. G06Q 20/12

(52) U.S. Cl. CPC G06Q 20/1235; G06Q 2220/10

(57) ABSTRACT

A client (e.g., an eReader) receives and displays a sample version of an e-book or other content to a user retrieved from a store server. The sample version is a subset of the full version of the content. The client establishes a location in the sample content as a purchase point. The location of the purchase point may be determined by a content server, the client, or another entity. If the user consumes the content past the purchase point, the client treats the user's action as the user's intent to purchase the full version of the content. The client automatically performs a purchase transaction for the full version of the content, and prepares the full version for consumption by the user. The client seamlessly transitions the user to the full version.

### BACKGROUND

1. Field of the Invention

This invention pertains in general to electronic books and other digital content and in particular to providing digital content to users.

2. Description of the Related Art

Electronic books (e-books) have become increasingly popular among consumers. Users use electronic devices such as dedicated electronic readers (e-readers), tablet computers, and smart phones to read the e-books and maintain libraries of e-books. A content provider may offer free samples of digital content to entice users to buy the full version of the content. For example, an e-book publisher may provide the first chapter or two of an e-book as a free sample to users. The users may decide to buy the full version of the content after reading the free sample.

The approach described above has several drawbacks that may reduce the number of users that ultimately purchase the full version of the content. For instance, once a user reaches the end of the free sample, the user must make a purchase decision, which interrupts the user's reading flow and could prevent the user from completing the purchase. Even if the user intends to purchase the full version, oftentimes, the user may need to exit the content to purchase the full version.

### SUMMARY

The above and other needs are met by methods, computer-readable storage media, and systems for automatically providing digital content to clients (e.g., to electronic devices for reading e-books) used by users.

One aspect provides a computer-implemented method for automatically providing digital content to a user. The method includes displaying a sample version of the digital content to a user of the client, where the sample version of the content is a subset of the full version of the content, and establishing a location of a purchase point in the sample version of the content at which automatic purchasing of the full version of the content occurs. The method also includes monitoring the user's current position in the sample version of the content relative to the location of the purchase point, and responsive to the monitored current position passing the purchase point, automatically purchasing the full version of the content for the user.

Another aspect provides a non-transitory computer-readable storage medium storing executable computer program instructions for automatically providing digital content to a user. The computer-readable storage medium stores computer program instructions for displaying a sample version of the digital content to a user of the client, establishing a location of a purchase point in the sample version of the content at which automatic purchasing of the full version of the content occurs, monitoring the user's current position in the sample version of the content relative to the location of the purchase point, and responsive to the monitored current position passing the purchase point, automatically purchasing the full version of the content for the user.

Still another aspect provides a system for automatically providing digital content. The system includes a non-transitory computer-readable storage medium storing executable computer program instructions for establishing a location of a purchase point in a sample version of the digital content at which automatic purchasing of the full version of the content occurs. The instructions are also for providing the sample version of the content with the established location of the purchase point in the sample version of the content to the client. The client is adapted to monitor a user's current reading position in the sample version of the content relative to the location of the purchase point. The instructions are further for receiving a message to purchase the full version of the content from the client responsive to the user's current reading position passing the purchase point and for automatically providing the full version of the content for the user responsive to receiving the message. The system additionally comprises a processor for executing the computer program instructions.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a computing environment supporting automatic purchasing of a full version of digital content responsive to continued reading of the corresponding sample version according to one embodiment.

FIG. 2 is a high-level block diagram of a computer for acting as a client, a content server and/or a store server in one embodiment.

FIG. 3 is a high-level block diagram illustrating a detailed view of the reader application module of a client according to one embodiment.

FIG. 4 is a diagram describing an uninterrupted reading experience provided by the environment of FIG. 1 according to one embodiment.

FIG. 5 is a flowchart illustrating steps performed by the client to automatically purchase a full version of digital content according to one embodiment.

FIG. 6 is a diagram illustrating interactions among the reader application module, the store application module, the content server and the store server to effect an automatic purchase transaction of a full version of digital content according to one embodiment.

The figures depict an embodiment of the invention for purposes of illustration only. One skilled in the art will readily recognize from the following description that alternative embodiments of the structures and methods illustrated herein may be employed without departing from the principles of the invention described herein.

### DETAILED DESCRIPTION

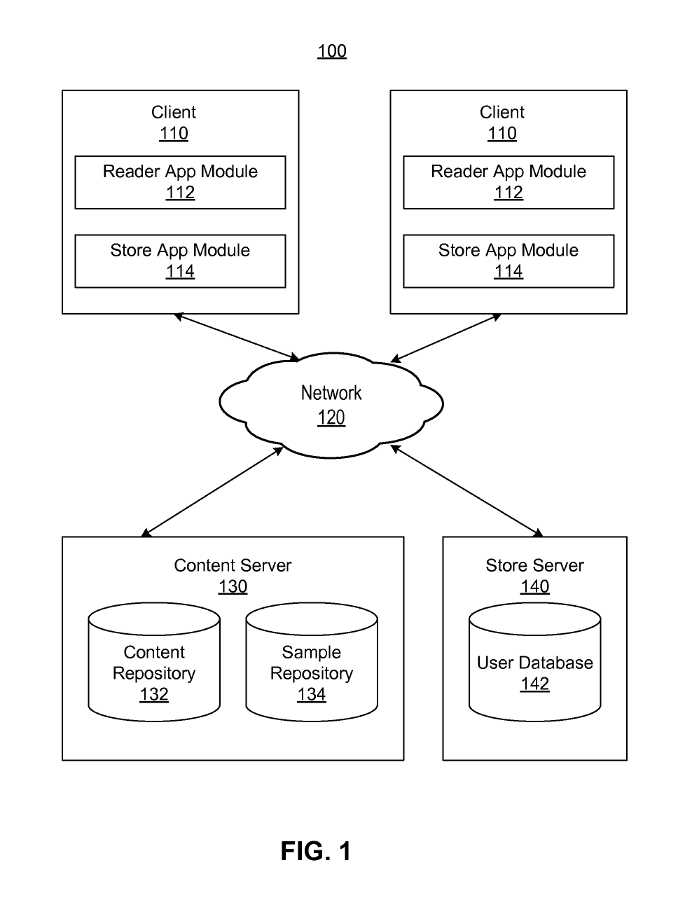

FIG. 1 is a high-level block diagram of a computing environment 100 supporting automatic purchasing of a full version of digital content responsive to continued reading of the corresponding sample version according to one embodiment. In this disclosure, “digital content” generally refers to any machine-readable and machine-storable work product, such as e-books, videos, and music files. In one embodiment, the computing environment 100 supports automatic purchasing of full versions of e-books for users based on the intent indicated by their continued reading of samples of the e-books. Hence, the following discussion often focuses on e-books. However, the techniques described below can also be used with other types of digital content.

FIG. 1 illustrates a content server 130, a store server 140 and two clients 110 connected by a network 120. Only two clients 110, one content server 130, and one store server 140 are shown in FIG. 1 in order to simplify and clarify the description. Embodiments of the computing environment 100 can have many clients 110, content servers 130, and store servers 140 connected to the network 120. Likewise, the functions performed by the various entities of FIG. 1 may differ in different embodiments.

A client 110 is an electronic device used by a user to perform functions such as consuming digital content, executing software applications, browsing websites hosted by web servers on the network 120, downloading files, and interacting with the content server 130 and store server 140. For example, the client may be a dedicated e-reader, a smart phone, or a tablet, notebook, or desktop computer. The client 110 includes a display device on which the user may view the text of e-books and other digital content. In addition, the client 110 includes a user interface (UI), such as physical and/or on-screen buttons, with which the user may interact to perform functions such as consuming digital content, selecting digital content, obtaining samples of digital content, and purchasing digital content.

The client 110 executes a reader application module 112 and a store application module 114. The reader application module 112 maintains a library of digital content and enables the user to consume the content, such as by displaying the text of an e-book on the display of the client 110. The store application module 114, in turn, enables the user to obtain e-books and other digital content via the network 120 and stores the content in the library. For example, the user can use the store application module 114 to obtain sample and full versions of e-books. Depending upon the embodiment, the reader application module 112 and store application module 114 may be standalone applications or integrated into the operating system or other software executing on the client 110.

The reader application module 112 interacts with the store application module 114 to support automatic purchasing of a full version of an e-book for a user based on the intent indicated by the user's continued reading of a sample version of the e-book. That is, the user's action to turn the page of the e-book past the purchase point indicates the user's intent to purchase the full version of the e-book. The automatic purchasing of a full version of an e-book reduces the cognitive burden to the user of deciding when and whether to download and purchase an e-book. A user can start reading any book in a library of e-books without needing to decide whether to download a free sample of the e-book or purchase the full version. Selecting an e-book from the library takes a user directly into the sample version of the e-book; the user's continued reading through a purchase point in the sample version triggers the automatic purchase transaction without any interruption in the user's reading experience.

In one embodiment, the reader application module 112 establishes a “purchase point” within the sample content of the e-book. The user may read the sample content up to the purchase point without being charged, and once the user reads past the purchase point, the reader application module 112 automatically purchases the e-book for the user and installs the full version of it on the client 112. By the time the user reaches the end of the sample content, the full version of the content is available on the client 110 and the reader application module 112 can seamlessly transition the user to the full content. “Seamless,” in this context, refers to a consistent and continuous transition from the sample version to the full version of the content, such that the transition is essentially unnoticeable by the user.

The location of the purchase point in the sample version of the content may vary. In one embodiment, the reader application module 112 establishes a location that minimizes time the user spends waiting for the full content to be installed on the client 110. For example, the purchase point may be located at an e-book several pages before the end of the sample content, so that the full versions of the content can be installed on the client 110 in the background while the user continues to read the sample content.

In one embodiment, the reader application module 112 determines the location of the purchase point within the sample version of the content. In another embodiment, the location of the purchase point is determined by the content server 130, store server 140, or another entity. The entity that determines the location of the purchase point may specify the location by inserting a tag or other data into the sample version of the content that is interpreted by the reader application module 112 as the location of the purchase point. Similarly, the entity may specify the location of the purchase point within metadata associated with the sample version of the content. The reader application module 112 reads the metadata and establishes the purchase point at the specified location.

In one embodiment, the user reads the sample content and passes the preselected purchase point in the sample, which activates the store application module 114. The store application module 114 instructs the store server 140 to retrieve purchase information associated with the user and to purchase the full version of the content for the user. After the purchase, the store application module 114 interacts with the reader application module 112 to cause the full version of the content to be installed in the user's library and seamlessly transition the user to the full version.

The content server 130 stores digital content and interacts with the reader application modules 112 of the clients 110 via the network 120 to provide the digital content to the clients. In one embodiment, the content server 130 stores a large amount of digital content from multiple publishers and distributors. The digital content may include e-books as well as other types of content such as movies and music.

In one embodiment, the content server 130 includes a content repository 132 storing full versions of content and a sample repository 134 storing samples of the full content. For example, the content repository 132 may store full versions of e-books while the sample repository 134 stores e-book samples associated with the full versions. Generally, a sample of digital content includes a subset of the content within the associated full version of the content, such as the first chapter of an e-book. Samples of digital content may be given to users by e-book publishers or distributors for free to entice the users to buy the full versions. In one embodiment, the e-book publishers designate portions of the digital content as free samples, and the distributor of the digital content may use their discretion as to whether and how to allow users to access the samples.

In one embodiment, the digital content in the content server 130, including the content in the content repository 132 and in the sample repository 134, is stored as a set of files and associated metadata. Each file is associated with particular content, such as a given e-book, and a single unit of content may be formed of one or more associated files. Further, in one embodiment the sample version of the content and the full version of the content are stored together in a single repository. For example, both versions of the content may be maintained together, except that the sample version of the content is unencrypted and the full version of the content is encrypted to prevent access to the non-sample parts of the content by users that have not purchased it.

The metadata for the files describe attributes of the content with which the files are associated. In one embodiment, the metadata include a volume identifier (ID) that is a string that uniquely identifies a given unit of content (e.g., an e-book). In addition, the metadata include a book format that defines the structure and semantics of the various components of an e-book for electronic publication. Examples of book formats include PDF (portable document format) and EPUB (electronic publication). The content of an e-book in PDF format is electronically published in a fixed-layout format. An e-book in EPUB format supports the publishing of the content in either fixed-layout format or flowable format.

The purchase point may be established differently in different e-book formats. For example, if the e-book is in a fixed-layout format, the location of the purchase point may be specified at a fixed page within the e-book. If the user moves past that page, the user's is considered to have intentionally purchased the full version of the e-book content. If the e-book is a flowable format, the location of the purchase point may be specified at a particular word, paragraph, or other location within the content. If the user reads past a displayed page that contains the location of the purchase point, the user is considered to have intentionally purchased the full version of the e-book content.

The metadata may further include an “offer type” flag that distinguishes between full versions and sample versions of content. The metadata may also describe, for example, the title, author, publisher, and classification of the content. In one embodiment, the metadata of the full versions of the content in the content repository 132 and the metadata of the associated sample versions of the content in the sample repository 134 are substantially the same. Thus, the sample version of an e-book has the same volume ID as the full version of the book. However, the offer type flag of the metadata is set to different values depending upon whether a given file pertains to the full version or a sample version of the content.

The store server 140 interacts with the store application modules 114 of the clients 110 and the content server 130 that provides digital content to the clients. The store server 140 may provide an online storefront that the user can browse using the client 110 to identify and obtain e-books and other content. For example, the storefront may allow users to purchase full and sample versions of content. The sample versions may be free or have a lower price than the full versions of the content.

In one embodiment, the store server 140 has a user database 142 which stores user profiles and purchase information associated with users registered with the store server 140. The purchase information of a user includes an identification of the user, payment method (e.g., a credit card), and/or other purchase information associated with the user (e.g., promotion codes, subscription membership). In one embodiment, the store server 140 registers a user responsive to the user selecting a free sample to read and obtains the purchase information from the user upon registration. Once a user is registered with the store server 140, the purchase information associated with the user is automatically retrieved from the user database 142 for automatic purchasing of full versions of content without further user input. In another embodiment, the purchase information associated with users is stored at the client 110. Responsive to a user reading past the preselected purchase point in the sample, the store application module 114 of the client 110 provides the purchase information associated with the user to the store server 140 for purchasing the full version of the content for the user.

The store server 140 also interacts with the store application modules 114 of the clients to process purchases of the full versions of content. In this instance, the store server 140 receives an indication that the user has passed the purchase point in a sample version of the content from store application module 114, retrieves identification, payment, and/or other purchase information associated with the user from the user database 142, and performs the purchase transaction for the full version of the content.

In one embodiment, the store server 140 maintains content libraries describing the content owned by users of the clients 110. The store server 140 accordingly updates its content library for a user to reflect that the user of the client has purchased the full version. The store server 140 also interacts with the content server 130 to cause it to provide the full version of the purchased content to the client 110.

The network 120 enables communications among the clients 110, the content server 130 and the store server 140 and can comprise the Internet as well as mobile telephone networks. In one embodiment, the network 120 uses standard communications technologies and/or protocols. Thus, the network 120 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

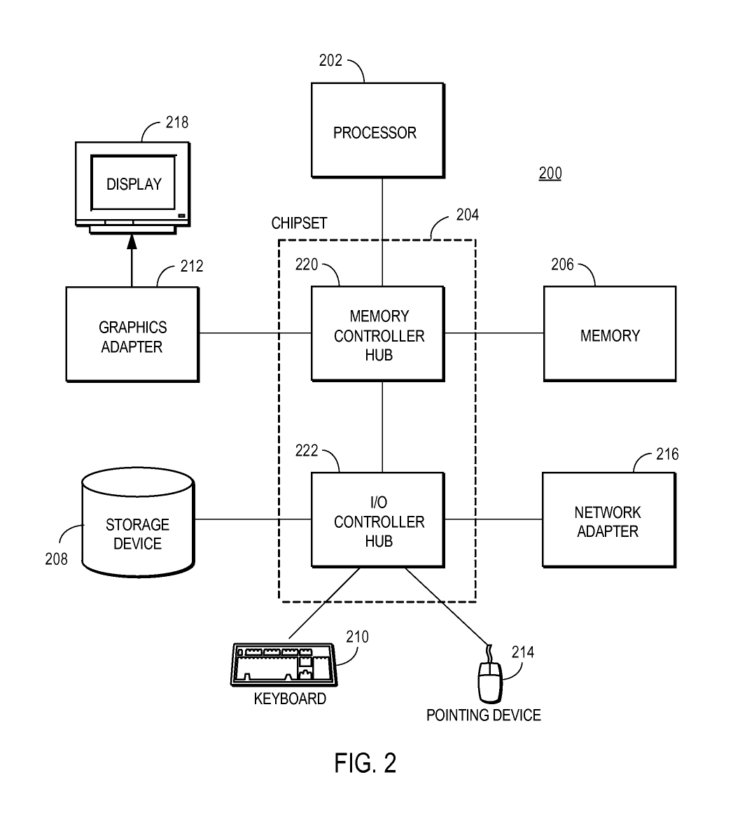

The entities shown in FIG. 1 are implemented using one or more computers. FIG. 2 is a high-level block diagram of a computer 200 for acting as a client 110, a content server 130 and/or a store server 140 in one embodiment. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 120.

As is known in the art, a computer 200 can have different and/or other components than those shown in FIG. 2. In addition, the computer 200 can lack certain illustrated components. For example, the computers acting as the content 130 and/or store 140 servers can be formed of multiple blade servers linked together into one or more distributed systems and lack components such as keyboards and displays. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

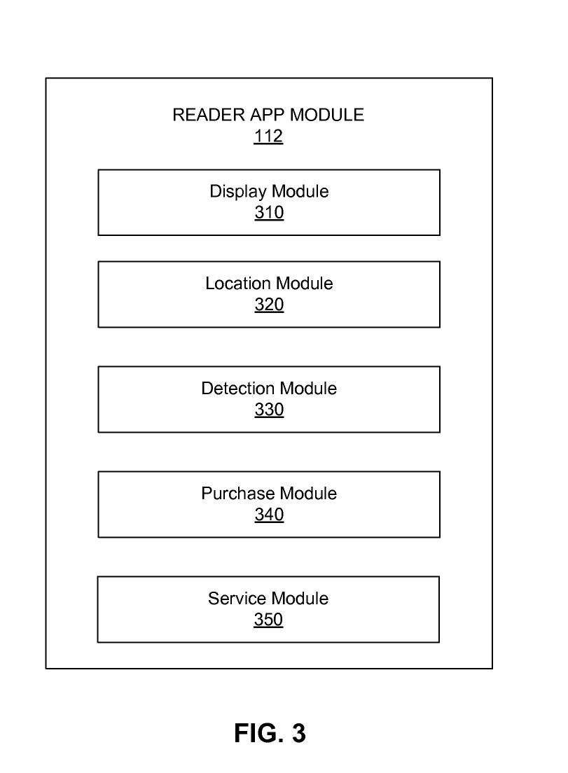

FIG. 3 is a high-level block diagram illustrating a detailed view of the reader application module 112 of a client 110 according to one embodiment. As shown in FIG. 3, the reader application module 112 includes a display module 310, a location module 320, a detection module 330, a purchase module 340 and a service module 350. Those of skill in the art will recognize that other embodiments of the reader application module 112 can have different and/or other modules than the ones described here, and that the functionalities can be distributed among the modules in a different manner.

The display module 310 displays digital content on the display device of the client 110. In one embodiment, the display module 310 displays pages of e-book text on the display device. In addition, the display module 310 displays UI elements, such as controls that allow the user to select and obtain content, input purchase information, and the like. The display module 310 also displays messages associated with the digital content, such as messages overlaid or adjacent to the digital content (e.g., in the margins of e-book content).

The location module 320 establishes a location in sample content at which automatic purchasing of the full version of the content occurs (i.e., the location of the purchase point). As mentioned above, in one embodiment the purchase point is at a location before the end of the sample content, which allows the user to purchase the full version of the content by reading past the purchase point and then continue to read the sample content (which is already installed on the client 110) while the full version is downloaded from the content server 130 to the client, decrypted, or otherwise prepared for reading. Once the full version is ready, the user is seamlessly transitioned from the sample version to the full version so that the user's reading experience is uninterrupted.

The location module 320 may use a variety of locating factors to establish the location of the purchase point in the sample version of the content. As mentioned above, in one embodiment the location of the purchase point is determined by the content server 130 or another entity and specified within the e-book content or within metadata associated with the e-book. In such embodiments, the location module 320 may be located within the content server 130, and the functions ascribed to the location module 320 herein may be performed before or when an e-book is provided to a client 110. In another embodiment, the location module 320 is within the client 110 as shown in FIG. 3 determines the location of the purchase point after the client receives the e-book from the content server 130.

Regardless of whether the location module 320 is in the content server 130 or the client 110, the locating factors may be based on the user and/or based on the content. User-based locating factors include the user's rate of consumption of the content (e.g., the user's reading speed), the user's demographic data, and the user's prior reading behavior with respect to other sample content (e.g., statistics describing amounts of sample content typically read by the user before the user quits the sample). In addition, user-based locating factors may be based on behaviors of an average or typical user, rather than on a specific user. The content-based locating factors include characteristics of the digital content, e.g., genre/classification of the content and the size of the file or files associated with the full version of the content. The locating factors may also include characteristics of the client used by the user (e.g., the bandwidth of the client's network connection).

In situations in which the servers and devices discussed here collect personal information about a user (e.g., the user's reading speed), or may make use of personal information, the user may be provided with an opportunity to control whether the user information (e.g., information about a user's social network, social actions or activities, profession, a user's preferences, or a user's current location) is collected. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information about the user is collected and used.

In one embodiment, the location module 320 uses the locating factors to determine the amount of time likely required to download the full version of the content to the client, decrypt the full version of the content, or otherwise prepare the full version for reading. The location module 320 also determines the rate at which the user is consuming the content. Then, the location module 320 selects a location for the purchase point in the sample content such that the user will reach the end of the content at approximately the same time, or a specified amount of time after, the full content is prepared.

For example, if the user is reading a sample e-book on the client 110, the location module 320 interacts with the content server 130 to determine the size (e.g., in bytes) of the file or files containing the corresponding full version of the e-book. The location module 320 also determines the bandwidth (rate of data transfer) of the network connection between the client 110 and the content server 130. Using these values, the location module 320 calculates the approximate amount of time it will take to download the full version of the e-book to the client 110. In addition, the location module 320 determines the speed at which the user is reading the e-book. The location module 320 may determine the reading speed by analyzing the rate at which the user turns the pages of the sample e-book, the user's average reading speed across multiple e-books, an average reading speed across multiple users, and/or using another technique. Then, the location module 320 determines the location in the sample e-book from which the user will finish the sample at approximately the same time the full version of the e-book is downloaded and establishes the purchase point at or near this location.

The location of the purchase point may also be determined independently from the locating factors. For example, the determined location may be at the end of the sample content, at an indicated percentage of the total sample content (e.g., 75% of the way through the sample), or at another place within the content. In addition, the location module 320 may use the locating factors in a different manner than described above. For example, the location module 320 may detect from the user's rate of consumption that the user is consuming the content quickly, and/or during a long reading session and mark the end of the long reading session as the purchase point (independent of the length of the sample content) in order to minimize the interruption of user's high engagement with the content.

The sample content may have more than one purchase point, such as a purchase point per chapter or per chunk of the sample content. In addition, the location module 320 may determine the location of the purchase point using combinations of the techniques described herein.

The detection module 330 monitors the user consumption of the sample content and distance between the user's current reading position and the location of the purchase point. Responsive to the user reading past the purchase point, the detection module 330 activates the purchase module 340 to purchase the full version of the content for the user. In one embodiment, the detection module 330 may use an application programming interface (API) to activate the purchase module 340.

In one embodiment, the detection module 330 interacts with the display module 310 to display messages related to the purchase point to the user. The detection module 330 may display messages to the user indicating that the user is approaching, has reached, and/or is past the purchase point. The message may be ambient in the sense that the messages are unobtrusive and do not interfere with the user's consumption of the digital content. For example, the detection module 330 may display messages in the margins of e-book content indicating the distance between the user's current reading position and the location of the purchase point, e.g., “5 pages until purchase point,” and “last page before the purchase point.” Optionally, the display module 310 may also display message indicating the completion of the purchase of the full version of the content, e.g., “It's your book now. Enjoy!” Other embodiments may display different messages or messages in a different medium, e.g., audio messages.

The detection module 330 may also monitor the client status, e.g., online or offline, in combination with the user's reading position and the purchase point. For example, if the user approaches and then reads past the purchase point in sample content while the client is offline (i.e., not in communication with the content server 130 and store server 140), the detection module 330 may instruct the display module 310 to display a message informing the user that the user has purchased the content, but will have limited reading capability until the client is online, e.g., “only part of this books has been downloaded. Read online to download the entire book.”

Assuming the client 110 is online and the user passes the purchase point in the sample content, the purchase module 340 interacts with the store application module 114 in the client 110 to purchase of the full version of the content. The purchase module 340 may use an API to provide the store application module 114 with the volume ID of the sample content and the user ID of the user of the client and indicate that the store application module 114 should retrieve the purchase information associated with the user from the user database 142 and perform a purchase transaction for the full version of the content.

In one embodiment, the store application module 114, once activated, retrieves the purchase information associated with the user and processes the purchase transaction. This processing may involve sending a purchase notification to the store server 140 that includes the purchase information, along with additional information used for the purchase, such as the volume ID, offer type, and other metadata identifying the purchased content. The store server 140 performs the transaction and communicates the result (e.g., “success” or “fail”) to the store application module 114. In turn, the store application module 114 communicates the result of the transaction to the user of the client 110.

The service module 350 transitions the user of the client 110 from the sample version to the full version of the content responsive to a successful purchase transaction. The service module 350 receives the full version of the content downloaded from the content server 130 to the client 110. The service module 350 can receive the downloaded content using a variety of different techniques. In one embodiment, the store server 140, upon processing the successful purchase transaction, instructs the content server 130 to download the content to the client 110. For example, the store server 140 may instruct the content server 130 to engage in a synchronization process with the client 110, which causes the reader application module 112 of the client 112 to synchronize its library of digital content with the library of content owned by the user stored by the store server 140. The client 110 downloads the full version of the content as a result of the synchronization. In another embodiment, the service module 350 directly downloads the full version of the content from the content server 130 responsive to the successful purchase transaction. In another embodiment, the service module 350 receives decryption keys or other decryption information from the content server 130 or another source which the service module 350 then uses to decrypt the full version of the content.

Once the full version of the content is on the client 110, the service module 350 replaces the sample version of the content at the client with the full version using a variety of techniques. In one embodiment, the service module 350 saves the full version of the content in the user's library on the client, determines the user's current reading position in the sample version, switches the user to the same reading position in the full version, and deletes the sample version from the user's library. The service module 350 may switch the user to the full version by instructing the display module 310 to display the full version of the content instead of the sample version after the end of sample version. In another embodiment, the service module 350 overwrites the sample version with the full version of the content, which automatically causes the display module 310 to display the full version of the content.

Regardless of the technique used for the transition, the transition is typically not noticeable to the user. Since the user can read the remaining content in the sample version while the transition to the full version occurs, the user's reading is not interrupted after the user passes the purchase point. If the user does exceed the scope of the sample content by, e.g., rapidly paging through the sample content, an embodiment of the service module 350 displays a “loading” page or other message indicating that the content is being retrieved.

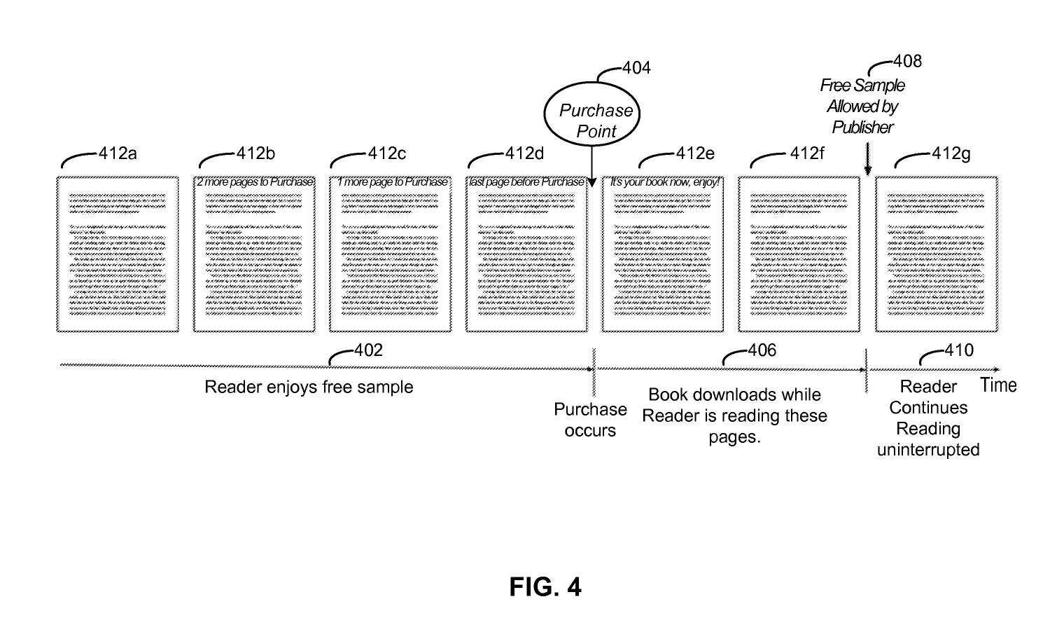

FIG. 4 is a diagram describing an uninterrupted reading experience provided by the environment of FIG. 1 according to one embodiment. The diagram in FIG. 4 illustrates six pages of sample content labeled 412a-412f and one page of full content 412g. In this example, the six pages 412a-412f were designated as a free sample by the publisher of the content. Thus, by agreement between the publisher and the distributor (e.g., an operator of the content server 130), the content server can provide these pages 412 to clients 110 free of charge. However, the distributor must pay the publisher for the content if the distributor provides the full content (e.g., page 412g and any subsequent pages) to the clients 110.

In one embodiment, the distributor who operates the content server 130 establishes a purchase point within the sample content and, by agreement with the user, charges the user for the content should the user read past the purchase point. The purchase point 404 in FIG. 4 is located between the fourth and fifth pages (i.e., between pages 412d and 412e).

As illustrated by the horizontal arrows shown below the pages in FIG. 4, the user's reading experience is divided into three time periods: a free sample reading period represented by arrow 402; a transitional reading period represented by arrow 406; and a full version reading period represented by arrow 410. The free sample reading period 402 occurs while the user is reading the free sample before reaching the purchase point. The pages in FIG. 4 illustrate that the client 110 displays ambient messages to the user during this period. The messages advise the user of the upcoming purchase point. In particular, page 412a does not include an ambient message because it is more than a threshold distance away from the purchase point (three pages away in this example). Pages 412b and 412c respectively display the ambient messages “2 more pages to purchase” and “1 more page to purchase.” Page 412d is immediately prior to the purchase point and therefore displays the message “last page before purchase.” In some embodiments, the ambient messages are displayed on only some of the pages leading up to the purchase point; the messages need not be displayed on consecutive pages. Page 412e is located after the purchase point and accordingly displays the message “it's your book now, enjoy!”

The transitional reading period 406 occurs after the user has passed the purchase point 404 but before the user has reached the end of the sample content. During this transitional period, the client 110 seamlessly obtains or otherwise prepares the full version of the content for consumption by the user. The user can continue to read the sample content during the transitional reading period 406. Page 412e is a portion of the sample content located immediately after the purchase point and accordingly displays the message “it's your book now, enjoy!” Eventually, the user reads past the end of the sample content (represented by page 4120. By this point, the client 110 has prepared the full content. The user may therefore continue to next page of content 412g (i.e., read the full content 410) without any interruption in the reading experience.

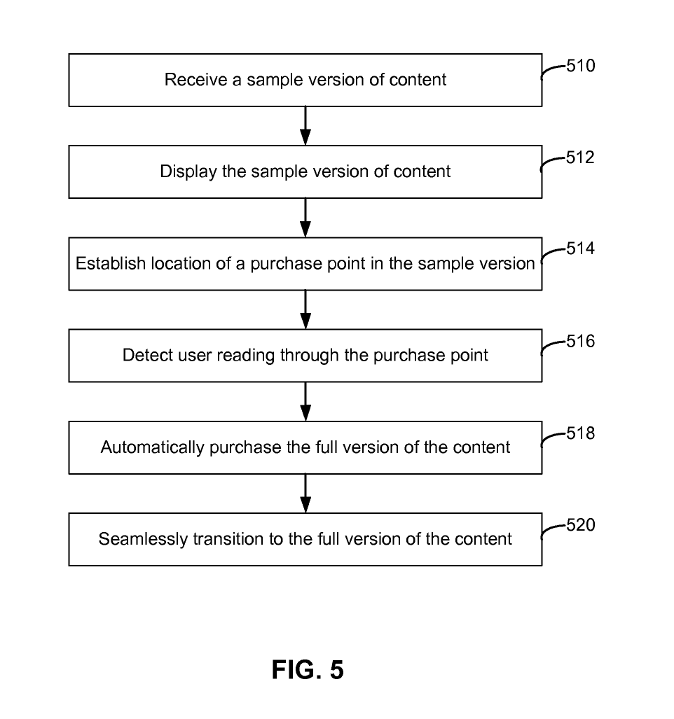

FIG. 5 is a flowchart illustrating steps performed by the client 110 to automatically purchase a full version of digital content according to one embodiment. Other embodiments perform the illustrated steps in different orders, and/or perform different or additional steps. Moreover, some of the steps may be performed by entities other than the client 110.

Initially, the client 110 receives 510 a sample version of content, such as an e-book retrieved from the store server 140, and displays 512 the sample version on a display device of the client 110. The sample version is a subset of the full version of the content, e.g., the first chapter or two of an e-book. The client 110 establishes 514 a location in the sample content at which automatic purchasing of the full version of the content occurs (i.e., the purchase point). The client may establish 514 the purchase point location by using data within the content or metadata associated with the content that identifies the location of the purchase point (such as a location determined by the content server 13) or my determining a location of the purchase point itself.

In one embodiment, the purchase point is established at a location that reduces the likelihood that the user will need to wait for the client 110 to prepare the full version of the content should the user read past the purchase point and past the end of the sample content. In one embodiment, the location of the purchase point is determined using locating factors such as characteristics of the user (e.g., the user's rate of consumption of the content), characteristics of the content, and characteristics of the client to determine the location of the purchase point.

The client 110 monitors the user's reading of the sample content and detects 516 the reader reading past the purchase point. In response to the user passing the purchase point, the client 110 interprets the continued reading through the purchase point as the user's intent to purchase the full version of the content. The client 110 therefore interacts with the store server 140 to automatically purchase 518 the full version of the content for the user. The client 110 then seamlessly transitions 520 the user from the sample to the full version of the content.

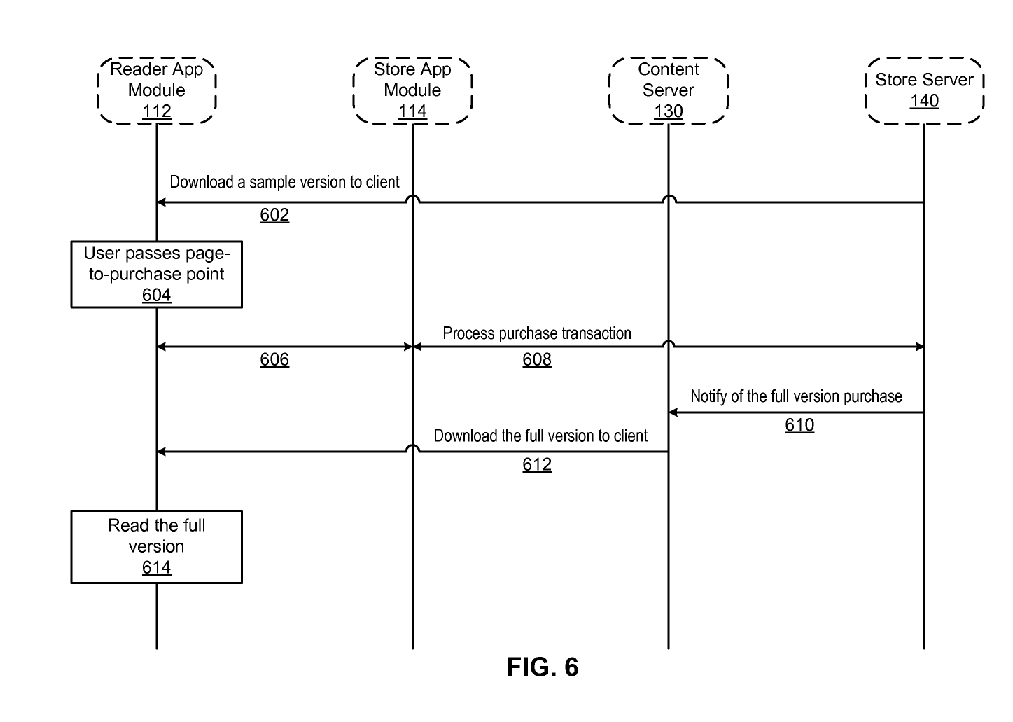

FIG. 6 is a diagram illustrating interactions among the reader application module 112, the store application module 114, the content server 130 and the store server 140 to effect an automatic purchase transaction of a full version of digital content according to one embodiment. The reader application module 112 initially downloads 602 the sample version of the content from the store server 140 and displays the sample to the user. The reader application module 112 establishes a location in the sample version of the content as a purchase point, at which automatic purchasing of the full version of the content occurs. The reader application module 112 may determine the location of the purchase point or use information within the content or within metadata associated with the content to identify the location of the purchase point.

The user of the client 110 reads the sample version of the content and, while reading, passes 604 through the purchase point. The reader application module 112 detects the user passing through the purchase point, and, in response, interacts 606 with the store application module 114 to process a purchase transaction for the content. The store application module 114 communicates 608 in turn with the store server 140 to process the purchase transaction.

If the purchase is successful, the store server 140 notifies 610 the content server 130 of the purchase and causes the content server 130 to download 612 or otherwise prepare the full version of the content for reading using the reader application module 112. The reader application module 112 seamlessly transitions the user from the sample version of the content to the full version. The user eventually passes through the end of the sample version of the content and continues 614 reading the full version of the content.

The techniques described above allow for multiple different use cases in which free and full versions of content are provided to users. For example, a user may establish a library of e-books that the user intends to read in the future. The user may add the sample versions of the e-books to the library without having to purchase the e-books. Later, as the user reads the e-books, the user may pay for the e-books individually as the user reads past the specific purchase points in each of the e-books.

Likewise, a distributor may offer e-books to the users using a variety of distribution models such as through free promotions, subscription models, and the like. The distributor may initially provide the users with the free sample versions of the e-books. The distributor may then recognize sales of the e-books, and make the corresponding payments to the e-book publishers, only when a reader reads passed the purchase point of a given e-book. In this way the users receive a seamless e-book reading experience yet costs are controlled because the distributor pays the publishers for only those e-books where the users read past the purchase points.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method of automatically providing digital content, comprising:
displaying a sample version of the digital content to a user of a client, wherein the sample version of the content is a subset of the full version of the content;
establishing a location of a purchase point in the sample version of the content at which automatic purchasing of the full version of the content occurs;
monitoring the user's current position in the sample version of the content relative to the location of the purchase point; and
responsive to the monitored current position passing the purchase point, automatically purchasing the full version of the content for the user.

2. The method of claim 1, wherein the full version of the content comprises an electronic book (e-book) having text, the sample version of the content includes a subset of the text in the full version of the e-book, and the purchase point is established at a location within the text of the sample version.

3. The method of claim 1, wherein establishing the location of the purchase point in the sample version of the content comprises:
determining a consumption rate indicating a rate at which the user is consuming the sample version of the content;
determining a download time indicating an amount of time to download the full version of the content to the client; and
selecting the location for the purchase point in the sample version of the content responsive to the consumption rate and the download time.

4. The method of claim 3, wherein selecting the location comprises selecting a location which allows the full version of the content to be downloaded to the client prior to the user consuming all of the sample version of the content.

5. The method of claim 1, further comprising:
displaying an ambient message describing the location of the purchase point to the user.

6. The method of claim 1, further comprising:
preparing the full version of the content for consumption by the user responsive to the full version of the content being automatically purchased; and
seamlessly transitioning the user from the sample version of the content to the prepared full version of the content.

7. The method of claim 6, wherein preparing the full version of the content comprises:
decrypting the full version of the content.

8. The method of claim 6, wherein preparing the full version of the content comprises:
downloading the full version of the content to the client.

9. A non-transitory computer-readable storage medium storing executable computer program instructions for automatically providing digital content, the computer program instructions comprising instructions for:
displaying a sample version of the digital content to a user of a client, wherein the sample version of the content is a subset of the full version of the content;
establishing a location of a purchase point in the sample version of the content at which automatic purchasing of the full version of the content occurs;
monitoring the user's current position in the sample version of the content relative to the location of the purchase point; and
responsive to the monitored current position passing the purchase point, automatically purchasing the full version of the content for the user.

10. The computer-readable storage medium of claim 9, wherein the full version of the content comprises an electronic book (e-book) having text, the sample version of the content includes a subset of the text in the full version of the e-book, and the purchase point is established at a location within the text of the sample version.

11. The computer-readable storage medium of claim 9, wherein the computer program instructions for establishing the location of the purchase point in the sample version of the content comprise instructions for:
determining a consumption rate indicating a rate at which the user is consuming the sample version of the content;
determining a download time indicating an amount of time to download the full version of the content to the client; and
selecting the location for the purchase point in the sample version of the content responsive to the consumption rate and the download time.

12. The computer-readable storage medium of claim 11, wherein the computer program instructions for selecting the location comprise instructions for selecting a location which allows the full version of the content to be downloaded to the client prior to the user consuming all of the sample version of the content.

13. The computer-readable storage medium of claim 9, further comprising computer program instructions for:
displaying an ambient message describing the location of the purchase point to the user.

14. The computer-readable storage medium of claim 9, further comprising computer program instructions for:
preparing the full version of the content for consumption by the user responsive to the full version of the content being automatically purchased; and
seamlessly transitioning the user from the sample version of the content to the prepared full version of the content.

15. The computer-readable storage medium of claim 14, wherein the computer program instructions for preparing the full version of the content comprise instructions for:
decrypting the full version of the content.

16. The computer-readable storage medium of claim 14, wherein the computer program instructions for preparing the full version of the content comprise instructions for:
downloading the full version of the content to the client.

17. A computer system for automatically providing digital content, comprising:
a non-transitory computer-readable storage medium storing executable computer program instructions for:
establishing a location of a purchase point in a sample version of the digital content at which automatic purchasing of the full version of the content occurs;
providing the sample version of the content with the established location of the purchase point in the sample version of the content to the client, the client adapted to monitor a user's current reading position in the sample version of the content relative to the location of the purchase point;
receiving a message to purchase the full version of the content from the client responsive to the user's current reading position passing the purchase point; and
automatically providing the full version of the content for the user responsive to receiving the message; and
a processor for executing the computer program instructions.

18. The system of claim 17, wherein the computer program instructions for establishing a location of the purchase point in the sample version of the content comprise instructions for:
specifying the location of the purchase point in the sample version of the content by inserting a tag into the sample version of the content, the client adapted to establish the location of the purchase point in the sample version of the content based on the inserted tag.

19. The system of claim 17, wherein the computer program instructions for establishing a location of the purchase point in the sample version of the content further comprise instructions for:
specifying the location of the purchase point within metadata associated with the sample version of the content, the client adapted to establish the location of the purchase point in the sample version of the content based on the metadata associated with the sample version of the content.

20. The system of claim 17, wherein providing the sample version of the content comprises providing a version of the content having an unencrypted sample portion and an encrypted full portion, and providing the full version of the content comprises providing the client with information adapted to be used by the client to decrypt the encrypted full portion.
